(19) United States
(12) Patent Application Publication
(10) Pub. No.: US 2008/0250150 A1
(43) Pub. Date: Oct. 9, 2008

(54) NETWORKED DISPLAY DEVICE

(76) Inventor: Kuo-Lung CHANG, Junghe City (TW)

Correspondence Address: SINORICA, LLC, 528 FALLSGROVE DRIVE, ROCKVILLE, MD, 20850, US

(21) Appl. No.: 11/842,284

(22) Filed: Aug. 21, 2007

(30) Foreign Application Priority Data
Apr. 3, 2007 (TW) 96111708

(51) Int. Cl. G06F 15/16

(52) U.S. Cl. 709/229

(57) ABSTRACT

A networked display device includes a memory, a network transmission module, a processing unit, an operational interface and a screen. The memory is to store a plurality of websites. The processing unit is to connect with one of the websites through the network transmission module to download at least a brief content and at least a URL from the website. The operational interface is to generate a command to have the processing unit to access data in the respective URL. The screen is to display the data.

### BACKGROUND OF THE INVENTION

(1) Field of the Invention

The invention relates to a display device, and more particularly to a networked display device capable of direct internet connection.

(2) Description of the Prior Art

Thanks to the improvement in computer and digital technology that more and more media files including photos, films and so on can be stored digitally in a memory card, a hard disk or any feasible website for future demonstration on a display. In particular, a digital photo frame that can show off the media files become one of the mainstream digital products to replace the conventional photo frame.

Referring to FIG. 1, a typical digital photo frame 10 is shown to have a memory 11, a processing unit 12, a transmission interface 13, a screen 14 and an operational interface 15.

The memory 11 is used to store multimedia files 110 in a jpg or mp4 format and to further store application programs 112 for displaying the aforesaid multimedia files 110. The processing unit 12 is to control the application programs 112 to enable the multimedia files 110 of the memory 11 to display on the screen 14. The transmission interface 13 between the memory 11 and the screen 14 can be a multi-function express card reader or a USB interface, such that the foreign multimedia files can be displayed on the screen 14 of the digital photo frame 10, inputted through the transmission interface 13 and processed by the appropriate application programs 112 of the processing unit 12.

The operational interface 15 includes a plurality of function keys 152, constructed directly on the digital photo frame 10 or on a remote control. These function keys 152 can perform actions of playing, continuous playing, random playing, page up, page down, on/off, pause and so on. As soon as any function key 152 is depressed, the respective application program 112 would be run by the processing unit 12.

Though the aforesaid conventional digital photo frame can display multimedia files, yet the multimedia files to be displayed thereon shall be provided and manually inputted by the user. In the case that the user does not provide a substantial amount of media files or he/she fails to update the multimedia files frequently, the digital photo frame would gradually loose its attraction and become as a left-over product.

A major reason to make the digital photo frame a left-over product is that the freshness upon limited multimedia files provided by the user would become stale and user's interests upon these multimedia files would quickly die down. On the other hand, if the multimedia files to be played on the digital photo frame can be automatically or periodically downloaded from websites, then the versatility in playing the digital photo frame would be expected and thus the user would be easy to pick up his/her interests with the digital photo frame.

### SUMMARY OF THE INVENTION

Accordingly, it is an object of the present invention to provide a networked display device, which can access websites directly.

It is another object of the present invention to provide an accessing method for the networked display device of the present invention.

In the present invention, the networked display device includes a memory, a wire or wireless network transmission module, a processing unit, an operational interface and a screen.

For the networked display device of the present invention is capable of self-networking, the user can default or pre-store a plurality of websites in the memory. The network transmission module can connect with any of the websites according to the 802.11 wireless or wire transmission standard. The processing unit can download at least a brief content and at least a uniform resource locators (URL) from a connected website whose address is pre-stored in the memory and whom is connected therewith by the network transmission module. The brief content can be a thumbnail or a wording to indicate the respective multimedia file. The URL can be the address of the multimedia file. After retrieved from the respective website (or web page), the brief content of the respective multimedia file can be displayed on the screen. Through the understanding upon the brief content, if the user has a further interest on the respective multimedia file, a command through the operational interface can be generated to have the processing unit download the multimedia file. Upon such an arrangement, the multimedia file can be completely displayed on the screen.

In the present invention, the processing unit can periodically and automatically download the brief contents and URLs provided by the preset websites. Further, the networked display device of the present invention can include a comparison unit and an alarm unit. The comparison unit is to compare the brief contents and see if a duplication in the specific brief content has been made by the processing unit and to further generate a comparison result. The alarm unit is to generate an alarm according to the comparison result. In the present invention, the alarm unit can be an LED indicator, and the alarm can be the flickering of the LED indicator.

The operational interface can include a plurality of function keys to respectively perform at least functions of downloading, broadcasting (or displaying), page up, page down, on/off and uploading. A download key thereon can produce a download command to control the processing unit to download the data or files indicated by the URL. A display key can produce a display command to control the processing unit to display the data or files indicated by the URL. A page-up key and a page-down key can be used to control the processing unit to display or select the preceding or following multimedia file. An upload key can produce an upload command to control the processing unit to upload data to a predetermined website or IP address.

In the present invention, the method for the networked display device of the present invention to access a website includes the steps of: establishing a network connection between the networked display device and the website, downloading at least a brief content and at least an URL from the website, accessing data indicated by the URL, and downloading the data to the networked display device.

In the present invention, if the brief content belongs to a network ballot, the method further includes the steps of: outputting an upload command to the website, and processing network balloting through the respective brief content provided by the website.

By providing the aforesaid networked display device of the present invention and the respective accessing method, the display contents of the networked display device can be positively renewed. Through the uploading operation provided by the present invention, the user can have better communication with partners on the internet or web 2.0.

All these objects are achieved by the networked display device described below.

### BRIEF DESCRIPTION OF THE DRAWINGS

The present invention will now be specified with reference to its preferred embodiment illustrated in the drawings, in which:

FIG. 1 is a schematic view of a typical digital photo frame;

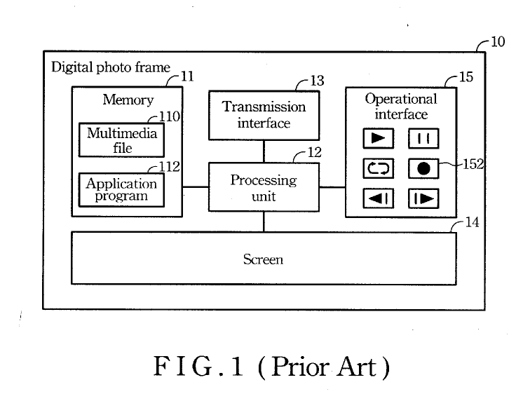

FIG. 2 is a block diagram of a preferred networked display device in accordance with the present invention;

FIG. 3 shows a diagram of the networked display device of FIG. 2 downloading multimedia files from a website; and

FIG. 4 is a flowchart showing how the networked display device of FIG. 2 downloads data from a website.

### DESCRIPTION OF THE PREFERRED EMBODIMENT

The invention disclosed herein is directed to a networked display device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

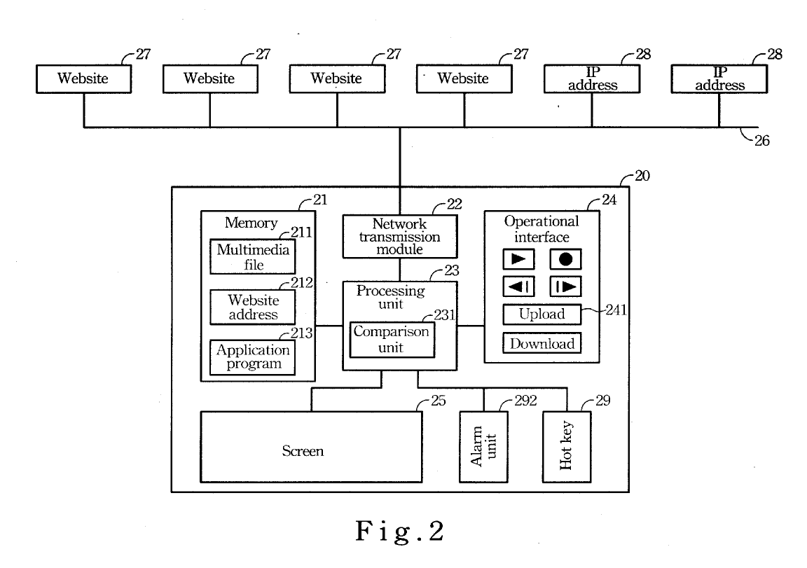

Referring now to FIG. 2, a block diagram of a preferred networked display device 20 with direct internet connection in accordance with the present invention is shown to have a memory 21, a network transmission module 22, a processing unit 23, an operational interface 24 and a screen 25.

The memory 21 is used to store data including multimedia files 211, website addresses 212 and various application programs 213 such as those for networking or displaying the multimedia files. The network transmission module 22 is used to process network connection and perform data transmission through an appropriate TCP/IP communication protocol. The network transmission module 22 can be wireless to connect with a network 26 through the 802.11 wireless transmission standard. Alternatively, the network transmission module 22 can connect with the network 26 through cabling.

The processing unit 23 can perform various application programs, commands and data processing. When the processing unit 23 receives a network connection command, a respective application program for networking would be performed to connect with the target website 27 for data accessing through the network transmission module 22.

The operational interface 24 can include a plurality of function keys 241, constructed directly on the networked display device 20 or on a remote control. These function keys 241 include at least a download key, a play (or display) key, a page-up key, a page-down key, an on/off key and an upload key. The download key can produce a download command to control the processing unit 23 to download the data or files from the websites 27. The display key can produce a display command. The page-up key and the page-down key can be used to control the processing unit 23 to display or select the preceding or following multimedia file. The upload key can produce an upload command to control the processing unit 23 to upload data to a website 27 or a predetermined IP address 28. The screen 25 is used to present the image signals outputted from the processing unit 23.

The following preferred networked display device in accordance with the present invention is to connect with a web 2.0 website or a web 2.0 portal website, which can provide interactive operations. The web 2.0 website can provide uploading, downloading, browsing and information-sharing. Further, the web 2.0 website can provide interactive service to its members and may also provide network balloting to select favorite or notorious websites. Therefore, in such a website, plenty of multimedia files including photos, films, music, or papers can be found. Also, the members can rate, vote and classify among these multimedia files. For example, these photos can be grouped into a most-favorite set, a most-funny set, a most-terrible set, and the top-10 photos can be ranked and posted for the members' interests.

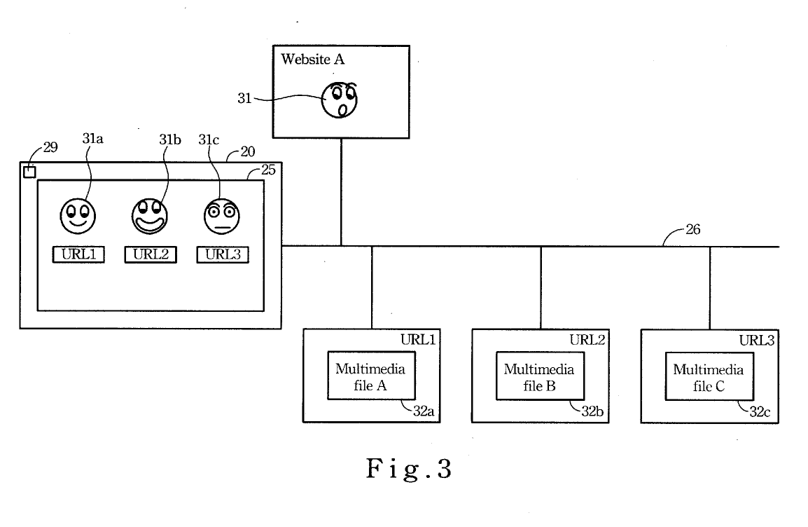

Referring now to FIG. 3, a diagram of the networked display device 20 of FIG. 2 downloading multimedia files from a website is shown. A user of the networked display device can pre-store a website A in the memory, and he/she can use a hot key 29 to have the processing unit performing internet connection with the website A so as to retrieve or download at least a brief content 31 and at least a URL from the website A, in which the brief content 31 can be a thumbnail or a wording of one of the most-funny multimedia files 32 voted by the network users and the URL can be the website address of the respective multimedia file 32. For example, in a download, the user may retrieve the brief contents 31 and the respective URLs of the multimedia files 32 in a top-ten list of the website A.

When a brief content 31 is retrieved from the website A, it can be posted to the screen 25 of the networked display device. Thereby, the user can have a basic understanding of the multimedia file 32 through the posted brief content 31. In the case that the user want to have a further understanding upon the multimedia file 21, he/she can produce a download command through the download key of the operational interface to have the processing unit connect to the respective URL for downloading the multimedia file 32. Then, the multimedia file 32 can be totally demonstrated on the screen 25.

For the ballot result in the website is varying from time to time, the networked display device of the present invention can be preset to download periodically and automatically the brief contents and URLs of the multimedia files. Further, to prevent from repeating download while in meeting similar lists of the multimedia files, the networked display device of the present invention can further include a comparison unit 231 and an alarm unit 292, as shown in FIG. 2. The comparison unit 231 is to compare if the processing unit downloads the same brief contents in two consecutive downloading and further generates a comparison result. The alarm unit 292 is to generate an alarm according to the comparison result. The alarm can be used to highlight the new-coming or un-seen multimedia files.

In one embodiment of the present invention, the alarm unit can be an LED indicator, and the alarm can be the flickering of the LED indicator. In the case that do difference is found between two consecutive download, which implies that all the brief contents have been reviewed by the user, the LED indicator will not flicker. On the other hand, if the comparison result shows the existence of new-coming multimedia files, the LED indicator would flicker to alert the user. Typically, the flicker frequency of the LED indicator can be defined to distinguish various types of difference in the comparison result. For example, a rush flickering of the LED indicator may define a comparison result that includes a large number of new-coming multimedia files. Upon such an arrangement, the user can be always aware of all the multimedia files available to his/her networked display device of the present invention, and thus no valuable files can be missed during the operation of the networked display device.

In an interactive website, the participants can download/upload files, communicate their individual opinions, and also process a network ballot upon the most popular multimedia files, for example. Therefore, by providing the networked display device of the present invention, the user can easily upload his/her vote upon a specific multimedia file through the upload key of the operation interface. In addition, a second upload key can be included in the operation interface to specifically upload the voting of the user.

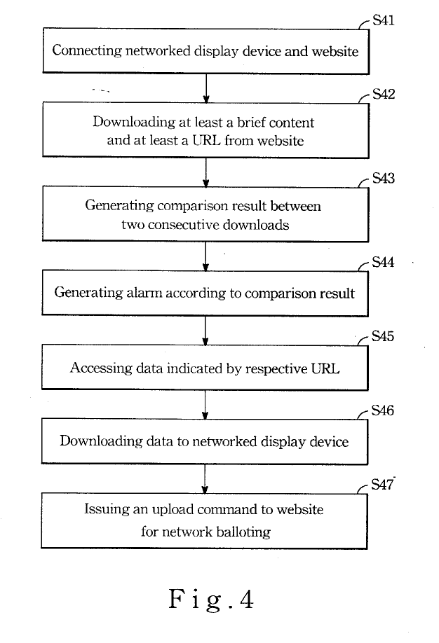

Referring now to FIG. 4, a flowchart shows how the networked display device of FIG. 2 downloads data from a website. The method for the networked display device of the present invention to access the website includes the steps of: establishing a network connection between the networked display device and the website (S41), downloading at least a brief content and at least a URL from the website to the networked display device (S42), generating a comparison result of the brief contents between the current download and the preceding download (S43), generating an alarm according to the comparison result (S44), accessing data indicated by the respective URL (S45), downloading the data to the networked display device (S46), and issuing an upload command to the website for network balloting upon the brief contents provided by the website (S47).

In particular in the foregoing step S45, the data to be accessed in the respective URL is the data other than the respective brief content.

By providing the networked display device and the access method for the networked display device in accordance with the present invention to replace the conventional digital photo frame, and the display contents can always be updated, the interaction with the website can be provided. Also, through the uploading function provided by the networked display device of the present invention, better information sharing and network interaction can be obtained between the network users or participants in the web 2.0 website.

While the present invention has been particularly shown and described with reference to a preferred embodiment, it will be understood by those skilled in the art that various changes in form and detail may be without departing from the spirit and scope of the present invention.

I claim:

1. A networked display device, comprising:
a memory for storing a plurality of websites;
a network transmission module for establishing connection with a network;
a processing unit, to connect with one of the websites through the network transmission module to download therefrom at least a brief content and at least a URL;
an operational interface for generating a command to have the processing unit to access data in the respective URL; and
a screen for displaying the data.

2. The networked display device according to claim 1, further including a comparison unit comparison unit for comparing said at least a brief content to see if a duplication in said at least a brief content has been made by said processing unit in consecutive downloading and further generating a comparison result.

3. The networked display device according to claim 2, further including an alarm unit for generating an alarm according to said comparison result.

4. The networked display device according to claim 1, wherein said brief content is a thumbnail, said URL is a website address, and said data is a multimedia file.

5. The networked display device according to claim 1, wherein said brief content is a wording, said URL is a website address, and said data is a multimedia file.

6. The networked display device according to claim 1, wherein said network transmission module is a module that processes data transmission through a TCP/IP communication protocol.

7. The networked display device according to claim 1, wherein said operational interface further includes at least a download key for generating a download command to have said processing unit to download said data in said respective URL.

8. The networked display device according to claim 7, wherein said operational interface further includes at least a display key for generating a display command to have said processing unit to display said data in said respective URL.

9. The networked display device according to claim 1, wherein said website is a web 2.0 website that provides interaction service.

10. The networked display device according to claim 1, wherein said brief content provided by said website is a network ballot result.

11. The networked display device according to claim 10, wherein said operational interface further includes at least an upload key for generating an upload command to process network balloting upon said brief content of said website.

12. An access method for a networked display device to access a website, comprising the steps of:
a. establishing a network connection between the networked display device and the website;
b. downloading at least a brief content and at least a URL from the website to the networked display device;
c. accessing data indicated by the respective URL; and
d. downloading the data to the networked display device.

13. The access method according to claim 12, wherein said website is a web 2.0 website that provides interaction service.

14. The access method according to claim 12, wherein said brief content provided by said website is a network ballot result.

15. The access method according to claim 14, further including a step of issuing an upload command to said website for network balloting upon said brief content provided by said website.

16. The access method according to claim 12, wherein said step b is performed periodically and automatically.

17. The access method according to claim 16, wherein said step b further including the steps of:
b1. generating a comparison result of said brief contents between a current download and a preceding download; and
b2. generating an alarm according to the comparison result.

18. The access method according to claim 17, wherein said step c is to access said data of said URL other than said brief content.
